(19) United States
(12) Patent Application Publication
(10) Pub. No.: US 2022/0201977 A1
(43) Pub. Date: Jun. 30, 2022

(54) Voice Command Pet Collar

(71) Applicant: Anita Bland, Milltown, IN (US)

(72) Inventor: Anita Bland, Milltown, IN (US)

(21) Appl. No.: 17/224,271

(22) Filed: Apr. 7, 2021

Related U.S. Application Data
(60) Provisional application No. 63/131,553, filed on Dec. 29, 2020.

(51) Int. Cl. A01K 15/02; A01K 11/00; A01K 27/00

(52) U.S. Cl. CPC A01K 15/023; A01K 11/008; A01K 27/006; A01K 27/009; A01K 27/001

(57) ABSTRACT

A voice command pet collar that is programmable with voice commands, audible alerts and vibrations designed to get the attention of a pet wearing the collar. The voice command collar resembles a regular pet collar but further includes a relatively small electronic unit having a microphone, GPS unit, wireless communication capabilities and additional features which may be useful in managing a pet or other animal. The voice command collar enables the pet owner to correct his or her pet's behavior using the plurality of prerecorded commands, and without the need to carry a separate remote control device to give electronic commands or other prompts to the pet. Additionally, the GPS feature of the voice command pet collar enables a pet owner to establish a perimeter around their home or other location, and ensure that the pet or other animal wearing the collar remains inside the established perimeter.

### CROSS-REFERENCE TO RELATED APPLICATION

The present application claims priority to, and the benefit of, U.S. Provisional Application No. 63/131,553, which was filed on Dec. 29, 2020 and is incorporated herein by reference in its entirety.

### FIELD OF THE INVENTION

The present invention relates generally to the field of pet accessories. More specifically, the present invention relates to a voice command pet collar that is programmable with voice commands, audible alerts and vibrations designed to get the attention of a pet wearing the collar, such as a dog or cat. The voice command collar of the present invention resembles a regular pet collar but further includes a relatively small electronic unit having a microphone, GPS unit, wireless communication capabilities and additional features which may be useful in managing a pet or other animal. The voice command collar enables the pet owner to correct his or her pet's behavior using a plurality of prerecorded commands, and without the need to carry a separate remote control device to give electronic commands or other prompts to the pet. Additionally, the GPS feature of the voice command pet collar enables a pet owner to establish a perimeter around their home or other location, and ensure that the pet or other animal wearing the collar remains inside the established perimeter. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various pet owners are always looking for accessories such as pet collars to aid in training their pets in a certain manner or fashion. Further, pet owners may use various tools and methods to train their pets, such as pet collars. Traditional pet collars are typically limited to a length of material or band that is put around the neck of a dog or other pet, and the collar is used in combination with a leash for restraining or training the dog or pet.

For example, many pet owners use a corrective or training collar to train their pet, such as a dog. The corrective collar comprises an electronic device that is operated by a remote control device, and that allows the pet or dog owner to correct the behavior of the dog or pet with the push of a button. More specifically, when the dog or pet owner activates the electronic device of the collar using the remote, the collar will vibrate, beep, or otherwise alert the dog or the pet to the behavior. Dog or pet owners will then voice the commands. However, using such corrective or training collars to train the dogs or other pets may be inconvenient for the dog or pet owners, as they have to control and operate the device, and the owners need to always carry the remote-control device with them. If the dog or other pet owner forgets to carry the remote-control device, the owner may not be able to operate the corrective dog collar to correct the behavior or actions of their pets, the failure of which could lead to a regression in the behavior of the pet. Additionally, even if the pet owner is carrying the remote, the pet owner needs to always be ready with the pet commands, and also needs to be within the receiving and transmitting distance in order for the two devices to work.

Further, existing training collars or device known in the art only work on correcting the behavior of the dog or pet wearing the device, but do nothing to prevent the dog or pet from straying away from the supervision of the pet owner or outside of an established boundary. For example, if an entry gate is left open or the pet is not on a leash, the pet may stray from the enclosed space and/or owner and become lost or injured (e.g., struck by a passing car). In such instances, the pet owner may be unable to locate his or her pet.

Therefore, there exists a long felt need in the art for a voice command dog or pet collar that enables the dog or pet owner to control the behavior of their pet and thereby enhance the training of the pet. There is also a long felt need in the art for a voice command pet collar which eliminates the need to use remote control devices to operate the pet collar. Additionally, there is a long felt need in the art for a voice command pet collar that does not require continuous attention by the pet owner to always be ready with a voice command to train or direct the pets. Moreover, there is a long felt need in the art for a voice command pet collar which prevent the dog or pet from straying away from the supervision of the pet owner, or outside of an established boundary. Further, there is a long felt need in the art for a voice command pet collar that enables a pet owner to track the location of his or her pet, and prevent the pet from being lost. Finally, there is a long felt need in the art for a voice command pet collar that is relatively inexpensive to manufacture and both safe and easy to use.

The subject matter disclosed and claimed herein, in one embodiment thereof, comprises a voice-controlled pet collar having a band structure with a buckle and a clip to secure the collar around the neck of an animal, such as a dog. The pet collar further comprises an integrated electronic circuit having a built-in microphone to prerecord voice commands, a speaker to play the prerecorded voice commands, a GPS unit to set an electronic perimeter, a volume control button for controlling the sound of the speaker, a wireless module to create a wireless connection with an electronic device and a vibration sensor to generate beeps, vibrations or other stimuli that correspond to a voice command to alert the pet wearing the collar to perform an action or stop an activity in accordance with the voice command. The collar device of the present invention can receive the voice command through the microphone, or through a wireless signal received from a smartphone application.

In this manner, the novel voice command collar of the present invention accomplishes all of the forgoing objectives, and provides a relatively easy, convenient and efficient solution to pet owners to both train their pets, as well as track their location. The voice command pet collar of the present invention is also user friendly, inasmuch as it does not require the user to carry a separate remote control to operate the collar and can be quickly operated using pre-recorded voice commands.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a voice controlled pet collar having a band structure that can be secured around the neck of a pet, such as a dog, cat or other domesticated animal, via a buckle and a clip. The voice controlled pet collar further comprises an integrated electronic circuit having a built-in microphone to prerecord voice commands, a speaker to play out the prerecorded voice commands, a GPS unit to establish an electronic perimeter, a volume control button for controlling the sound of the speaker, a wireless module to create a wireless connection with an electronic device, and a vibration sensor to generate beeps, vibrations or other stimuli corresponding to a voice command to alert the animal wearing the collar to perform an action or stop an activity in accordance with the voice command. The pet collar can receive the voice command through the microphone, or through a wireless signal from a mobile application on an electronic device such as, but not limited to, a smartphone.

In a further embodiment of the present invention, a pet collar designed for communication with a pet wearing the collar and locating the pet is disclosed. The novel pet collar comprises an electronic circuit integrated to the band of the collar. The electronic circuit has both location tracking and communication elements, as well as a wireless communication module to create a wireless channel with a smartphone, other electronic device or a remote control. One or more speakers are also positioned along the collar to play out commands and other audio tones. The collar device further comprises one or more microphones to input voice commands, a GPS unit to locate a pet wearing the collar device, an internal memory to store the voice commands and a vibration sensor to beep or alert the pet with vibrations or other stimuli to give instructions to the pet, which are sent through a voice command by the pet owner using at least one of the microphone of the dog collar, an input on the wireless remote control or a mobile application.

In yet another embodiment of the present invention, a method of controlling and instructing a pet through a plurality of commands sent to an electronic pet collar worn by the pet is disclosed. The method comprises the steps of programming the pet collar using voice commands, wherein the voice commands are stored in an internal memory of the pet collar along with different vibration or other stimuli levels. The pet collar is then placed around the neck of a pet, such as a dog, cat or other domesticated animal. Next, the collar or accessory is activated using a command such as a voice command or a wireless signal sent via a remote control. Once received, the command triggers the pet collar to generate a vibration, alert or other stimuli along with an audible command to instruct the pet to perform a corresponding action or stop an undesirable activity.

In a further embodiment of the present invention, a method of wirelessly establishing a geofence for a pet and sending an alert to the pet upon crossing the geofence is disclosed. The method comprises the initial steps of providing a collar having an electronic circuit thereon, and programming the electronic circuit to establish a geofence. The programming may be accomplished by use, or by at least one of a smartphone application, a remote control or a microphone on the pet collar. The collar is then attached to the neck of the pet. Next, an audio message and a vibration or other signal is generated from the pet collar to the pet when the pet is approaching the geofence to indicate to the pet that the boundary is close. Finally, a shock is sent through the pet collar to the pet once the geofence has been breached to indicate to the pet to return to the proper side of the geofence, wherein the collar will not initiate a second shock to the pet when it is re-entering the geofence.

In yet another embodiment of the present invention, a system for wirelessly monitoring a pet using a wireless signal is disclosed and comprises an electronic pet collar. The collar includes an electronic unit having both location detection and communication elements and a remote control to wirelessly pair with the electronic pet collar. The remote control device sends wireless signals to the electronic pet collar using input controls present on the remote control, wherein the wireless signals enable the user to determine the precise location of the pet wearing the electronic pet collar.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the voice command pet collar of the present invention in accordance with the disclosed architecture;

FIG. 2 illustrates a perspective view of a dog wearing one potential embodiment of the voice command pet collar of the present invention in accordance with the disclosed architecture, wherein the collar administers a shock to the dog as it crosses the geofence;

FIG. 3 illustrates a perspective view of one potential embodiment of the voice command pet collar of the present invention attached to a dog in accordance with the disclosed architecture, wherein a user has activated the collar via a voice command and the dog is responding to the voice command;

FIG. 4 illustrates a perspective view of one potential embodiment of the voice command pet collar of the present invention attached to a dog in accordance with the disclosed architecture, wherein a user has activated the collar via a voice command initiated into a mobile application and the dog is responding to the voice command;

FIG. 5 illustrates a flow diagram of one potential method of using the voice command pet collar of the present invention in accordance with the disclosed architecture; and

FIG. 6 illustrates a perspective view of one potential embodiment of a remote control that may be paired with the voice command pet collar of the present invention in accordance with the disclosed architecture, wherein the remote control may be used to activate the pet collar.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a voice command dog or pet collar that enables the dog or pet owner to control the behavior of their pet and that enhances the training of the pet. There is also a long felt need in the art for a voice command pet collar which eliminates the need to use remote-control devices to operate the pet collar. Additionally, there is a long felt need in the art for a voice command pet collar that does not require continuous attention by the pet owner to always be ready with a voice command to train or direct their pets. Moreover, there is a long felt need in the art for a voice command pet collar which prevents the dog or pet from straying away from the supervision of the pet owner, or outside of an established boundary. Further, there is a long felt need in the art for a voice command pet collar that enables a pet owner to track the location of his or her pet, and that prevents the pet from being lost. Finally, there is a long felt need in the art for a voice command pet collar that is relatively inexpensive to manufacture and both safe and easy to use.

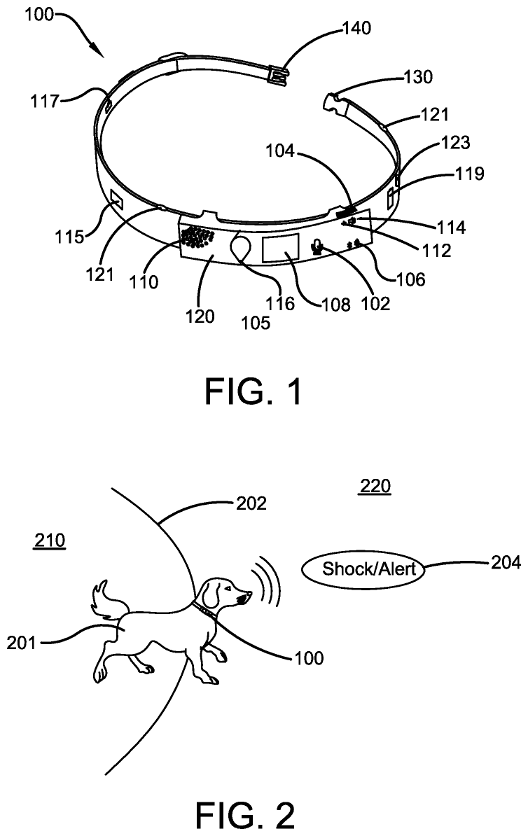

Referring initially to the drawings, FIG. 1 illustrates a perspective view of one potential embodiment of the voice command pet collar 100 of the present invention in accordance with the disclosed architecture. As shown, the voice command collar 100 looks like a conventional pet collar or accessory. However, the voice command collar 100 is an intelligent collar with an electronic circuit 120 that can be programmed with various rules and voice commands, and has wireless communication capabilities. More specifically, the voice command pet collar 100 has a microphone 102, which is used to program the collar 100 with various voice commands, and that allows a user to store pre-recorded commands, messages, or greetings in the collar 100. The collar 100 is preferably comprised of a relatively flexible or deformable material so that the collar can be placed around the neck of the animal, similar to a traditional collar.

The voice command collar 100 is further comprised of a control button 104 which may be used to program and/or select a particular mode of operation to control the dog or pet wearing the voice command collar 100. In addition, the collar 100 can include a timer circuit 111 so that messages can be emitted in a specific cycle or at timed intervals if, for example, the pet owner is away at work or asleep but nonetheless wishes to activate the collar 100 and have the same issue a prerecorded message or command to the pet such as, but not limited to, “good boy/girl,” or to have the collar 100 play other soothing sounds for the benefit of the pet.

The voice command pet collar 100 is also preferably comprised of a smart housing 105 having a number of different components, and that is connected to the collar 100 by fasteners or clips 107 such that the smart housing 105 can be easily removed from the collar 100 for servicing, cleaning and/or placement on another collar. Where the smart housing 105 is removable from the collar 100, it connects to other elements in the collar 100 such as the LEDs or sensors either by hardwiring in the collar or via a wireless connection.

The smart housing 105 is comprised of a wireless communication module 106 to provide Bluetooth or other Wi-Fi capabilities to operate the dog collar 100 wirelessly using voice commands, or through instructions received from a paired remote control. In one embodiment, a smartphone can also be used as a remote control for controlling or operating the voice command pet collar 100. The pet collar 100 may further comprise a vibration sensor 108 that will vibrate for a user selected duration when activated by a particular voice command issued by the user. Said vibrations can be used as a training tool by the user to provoke a particular action by the pet wearing the collar 100, or to stop an otherwise undesirable activity, such as scratching, digging, running or the like.

The voice command pet collar 100 further comprises a built-in speaker 110 to play the instructions given by the pet owner either through a voice command or using a control on a remote control device. Volume control buttons 112, 114 are also present on the surface of the dog collar 100 to increase or decrease the volume of the speaker 110 to suit user need or preference. The collar 100 may also comprise or more additional sensors 115, 117, which can provide temperature readings, wetness or motion detectors such as when the pet is regularly scratching at their collar, or when the collar 100 becomes caught on an object so that the pet owner knows that some event has occurred that requires the owner's intervention.

One of the important features of the voice command dog collar 100 of the present invention is that it has a built-in GPS chip 116 in the electronic circuit 120 that can be used to set a perimeter or geofence around a specific location, such as the owner's property line, to set a limit or boundary for the dog wearing the dog collar 100. Once the dog or other pet approaches or crosses the geofence/perimeter, an alert or vibration of higher intensity is provided by the voice command dog collar 100 to the dog or pet. The collar 100 may also have prongs to provide the alert, or vibrate at a higher intensity, when the dog or pet crosses the perimeter or boundary. For vibration, any of a motor-drive based vibrator, a ceramic based vibrator, a percussion-based vibrator or a transducer-based vibrator can be used. A microprocessor is also present within the electronic circuit 120 that interprets electrical signals from the various electronic components within the dog collar 100 to allow for several operating modes and collar functions during deployment.

The dog collar 100 can be activated or deactivated using the voice command of the owner, trainer or pet sitter. The dog collar 100 has an internal memory 118 to store voice commands programmed by the user, and the speaker 110 plays the voice commands in the voice of the operator such that the dog wearing the dog collar 100 is trained by hearing the voice of the dog owner, trainer or sitter. The collar 100 allows for multiple different voices to be used so that multiple people in the pet's life, such as other members of the owner's family, a pet trainer, sitter or the like may instruct the pet. In this way, no one single person is required to be present to provide instruction to the pet in order to train and or protect the animal. The collar 100 of the present invention can be used by professional dog trainers to train dogs, and does not require a leash to control and train the pet. Further, the wireless feature of the collar 100 enables the pet owner, trainer or sitter to control and monitor the pet wirelessly in a simplified manner using the voice commands.

In a further embodiment of the present invention, the pet collar 100 may further comprise a USB or mini-USB charger to charge various components of the dog collar 100 and a battery 119 to provide power when the charger is not connected to the collar 100. The battery 119 may be provided on the collar 100 and the smart housing 105 is connected to the battery 119, or the battery 119 may be disposed within the smart housing 105. The electronic circuit 120 may be present within a housing of the dog collar 100, or can be removably attached to the surface of the dog collar 100. The GPS unit 116 is used to provide positional information to track the pet wearing the dog collar 100. For example, once the pet wearing the collar 100 crosses or comes in close proximity to a user-defined perimeter, an audible and or visual notification is sent by the collar 100 to the owner (e.g., the smartphone, remote control or other electronic device) to alert the owner of the position or location of the pet. The GPS unit 116 is imperative in situations where a pet is able to leave its residence and stray over great distances.

The pet collar 100 may further comprise one of more LED lights 121 to illuminate the collar 100 in the dark in order for the owner or pet sitter to locate the animal. The LED lights 121 may illuminate in different colors corresponding to different voice commands of the dog owner, and are powered by the battery 119. Further, the GPS unit 116 provides electronic fencing based on the distance the pet has traveled from a central unit, and also provides a tone to warn the pet that they are about to get a shock or alert as they approach the fence boundary. A different signal, such as one related to the pet receiving a treat, may be played when the pet re-enters the allowable area defined by the electronic fence to incentivize the pet to re-enter said area.

As previously stated, the collar 100 has a buckle 130 and a clip 140 for attaching the collar to the neck of a pet, wherein the buckle 1300 may further comprise a key-locking mechanism that locks the clip 140 into the buckle 130 when engaged. The collar 100 is also preferably made of a slash-proof material, such as leather, nylon webbing, polyester, hemp, metal, or “oilcloth” so that the same cannot be tampered with. The dog collar 100 serves as a means of communication, location and identification.

FIG. 2 illustrates a perspective view of a dog 201 wearing one potential embodiment of the voice command pet collar 100 of the present invention in accordance with the disclosed architecture, wherein the collar 100 administers a shock to the dog 201 as it crosses the geofence; 202. As stated earlier, an electronic fence 202 using the GPS sensor 116 can be created based on the need of an owner, trainer, or sitter. In the present embodiment, the electronic fence 202 is created and defines an inclusion area 210 for the pet, and an exterior area 220. When a pet such as a dog 201 wearing the dog collar 100 approaches the electronic fence 202 and tries to enter the exterior area 220, the pet collar 100 gives an alert or a shock 204 to the pet, signaling to the pet not to proceed any further and to return to the inclusion area 210. In one embodiment, the collar 100 continues creating the alert or shock 204 until the dog 201 comes back within the perimeter of the electronic fence 202 or when the dog owner deactivates the electronic fence 202, such as when taking the pet for a walk or to greet another individual beyond the perimeter. Over time, the dog 201 learns about the electronic fence perimeter 202 due to the shock 204, and will remain in the inclusion area 210.

It should be appreciated that there can be a plurality of sensitivity levels of shocks or stimuli 204 which can be selected by the dog owner, trainer or sitter using a remote control or using the control buttons present on the dog collar 100. When the dog 201 crosses the electronic fence 202, a notification is also sent to the dog owner in the form of any visual or audio manner to notify the owner that the pet 201 has crossed the electronic fence boundary 202. In one embodiment, based on different locations such as home or office of the pet owner, different electronic fences 202 can be configured to work in conjunction with the dog collar 100. For example, the electronic fence 202 can be configured using a voice command by, for example, stating a range such as “30 meters” or the like. The fence boundary 202 can be established either outside of the home or office or within the interior of the home or office.

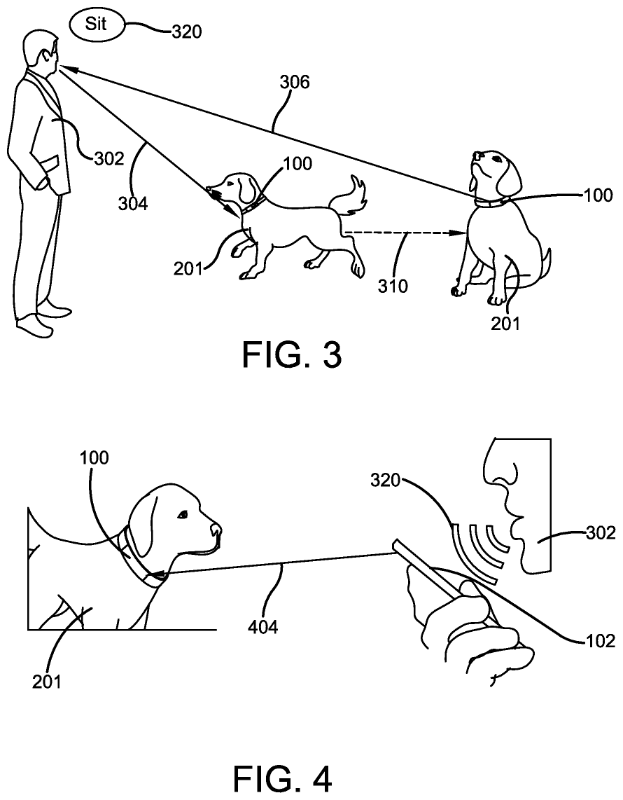

FIG. 3 illustrates a perspective view of one potential embodiment of the voice command pet collar 100 of the present invention attached to a dog 201 in accordance with the disclosed architecture, wherein a user 302 has activated the collar 100 via a voice command and the dog 201 is responding to the voice command. As shown, the dog or pet owner 302 sends a programmed voice instruction such as “Sit” 320 to the collar 100, which is picked up by microphone 102 of the collar 100 after travelling through the medium 304. The dog 201 wearing the collar 100 receives a beep or vibration produced by the vibration sensor 108, optionally along with an instruction played out of the speaker 110 of the dog collar 100 and performs the action as per the received instruction. As shown, the dog or pet 201 makes a transition 310 from the standing position to a sitting position, thereby sending an inherent acknowledgement 306 to the dog owner 302. The collar 100 may be pre-programmed with various voice commands using the microphone 102 of the dog collar 100 when the collar 100 is configured in a programming state using the control button of the collar 100. Various levels of beeps or vibrations can be associated with each pre-programmed command in the collar 100.

FIG. 4 illustrates a perspective view of one potential embodiment of the voice command pet collar 100 of the present invention attached to a dog 201 in accordance with the disclosed architecture, wherein a user 302 has activated the collar 100 via a voice command initiated into a mobile application and the dog 201 is responding to the voice command. As shown, a dog owner 302 pairs a mobile application installed on a smartphone 402 or other electronic device with the collar 100 using a wireless communication channel 404, such as Bluetooth, Wi-Fi, RFID, NFC or the like. Next, the pet owner 302 gives a voice command 320 using the microphone of the smartphone 402 that is wirelessly transmitted to the collar 100 through the communication channel 404. Upon receipt, the speaker 110 of the collar 100 plays out the voice command along with a beep or vibration of a pre-programmed intensity that corresponds to the voice command to alert the pet 201 to perform a certain action or to stop engaging in an activity that corresponds to the voice command. Using the smartphone application, the dog owner 302 can also set the geofence 202 for the pet 201, and can receive notifications once the pet 201 wearing the collar 100 crosses the geofence 202.

The voice command collar 100 of the present invention is preferably durable, non-slippery, waterproof and scratch proof. The internal battery 119 of the collar 100 preferably runs up to 40 hours or more between charges. The internal battery 119 can be recharged using the USB/mini-USB charger 123, as best shown in FIG. 1. In one embodiment, the collar 100 may support built-in high capacity lithium rechargeable batteries as the battery 119, though other batteries may also be supported.

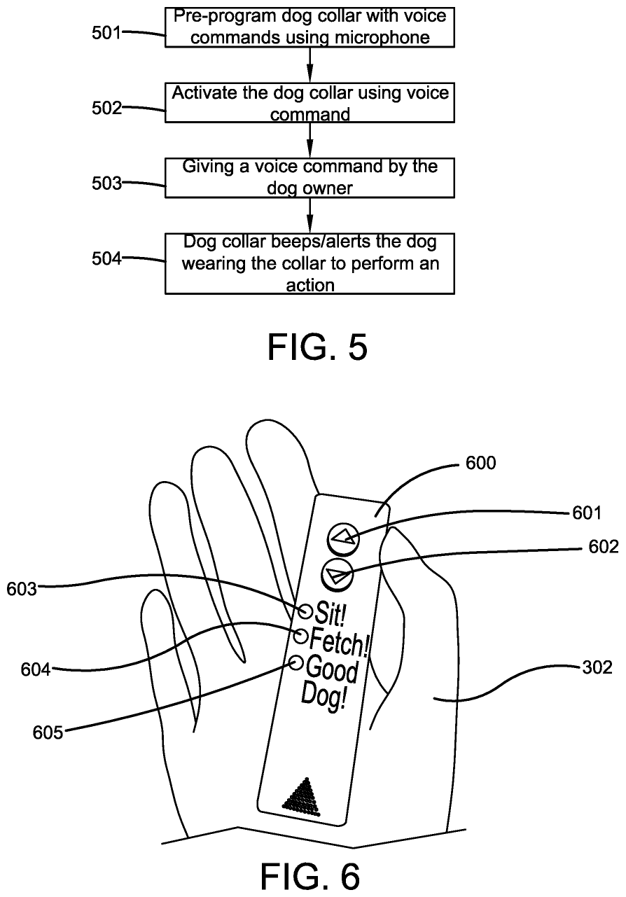

FIG. 5 illustrates a flow diagram of one potential method of using the voice command pet collar 100 of the present invention in accordance with the disclosed architecture. Initially, at block 501, the dog collar 100 of the present invention is pre-programmed with voice commands using the built-in microphone 102. The voice commands are stored in an internal memory 118 of the collar 100 along with a corresponding beep, vibrate, or alert level. To use the collar 100, the collar 100 is worn around the neck of a pet 201, and is activated using a voice command or manually through a control button at block 50. At block 503 and once the collar 100 is activated, the pet owner 302 can give a voice command to the collar 101 directly or through a smartphone application. Upon receiving the voice command, the collar 100 generates a beep or vibration indicating to the dog 201 wearing the collar 100 to perform an action or to stop engaging in an activity at block 504.

FIG. 6 illustrates a perspective view of one potential embodiment of a remote control 600 that may be paired with the voice command pet collar 100 of the present invention in accordance with the disclosed architecture, wherein the remote control 600 may be used to activate the pet collar 100. As shown, the user 302 holds the remote control 600 to operate the voice command collar 100 to correct the behavior of the pet, or to train the pet 201 as desired. The remote control 600 may comprise various control buttons such as, but not limited to, a Volume Up 601, Volume Down 602, “Sit” command button 603, “Fetch” command button 604 and “Good Dog” command button 605.

The Volume Up 601 may be used to increase the speaker volume of the collar 100, whereas the Volume Down 602 button can be used to decrease the speaker volume of the collar 100. When the “Sit” command button 603 is activated, the collar 100 will vibrate at a particular sensitivity and/or the “Sit” command may be given using the speaker 110 positioned on the collar 100. Similarly, upon activation of the “Fetch” command button 604, the collar 100 triggers a separate type of alert, such as a long vibration or the like, and/or may also give the “Fetch” command on the speaker 110 of the collar 100. Upon activation, the “Good Dog” button 605 may notify the pet 201 that a treat is available as a positive reward for the good behavior that prompted the pet owner to press the button 605, or may simply give the respective command using the speaker 110 of the collar 100. Nonetheless, the control buttons on the remote control 600 are not so limited, and any other control buttons can be incorporated into the remote control 600 as per the needs and/or preference of the pet owner 302.

The remote control 600 may utilize advanced RF433 MHZ technology that boosts the remote range up to 300 meters. Nonetheless, the remote control 600 may also support other technologies known in the art to increase the range of effective communication, and enhance the user experience. The remote control 600 may also include rechargeable batteries, which can be easily charged as per the desires of the user. Once the battery of the remote controller 600 is fully charged, the battery of the remote 600 may last up to 100 hours or more.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “modified pet collar”, “voice command collar”, “voice command dog collar”, “voice operative pet collar”, “voice-controlled dog collar” and “voice command pet collar” are interchangeable and refer to the voice command pet collar 100 of the present invention.

Notwithstanding the forgoing, the voice command pet collar 100 of the present invention and its various components can be of any suitable size and configuration as is known in the art without affecting the overall concept of the invention, provided that it accomplishes the above stated objectives. One of ordinary skill in the art will appreciate that the size, configuration and material of the voice command pet collar 100 as shown in the FIGS. and its various components are for illustrative purposes only, and that many other sizes and shapes of the voice command pet collar 100 are well within the scope of the present disclosure. Although the dimensions of the voice command pet collar 100 are important design parameters for user convenience, the voice command pet collar 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet accessory comprising:
a deformable band sized and configured to fit around a neck of a pet;
the band having a buckle to fasten the band securely to the pet; and
a smart housing removably secured to the band, wherein the smart housing comprises an integrated circuit, a microphone, a speaker, and a GPS module.

2. The pet accessory as recited in claim 1, wherein the smart housing is secured to the band by one of a clip or a fastener.

3. The pet accessory of claim 2, wherein the smart housing further comprises a wireless communication module, a memory and at least one sensor.

4. The pet accessory of claim 3, wherein the at least one sensor monitors at least one of the following relative to the pet: a temperature, a wetness, a motion, a heart rate, or a combination thereof.

5. The pet accessory of claim 1, wherein the pet accessory is a collar.

6. The pet accessory of claim 1, wherein the band further comprises an LED light that is illuminated when a sound is emitted from the speaker.

7. The pet accessory of claim 4 further comprising a battery.

8. The pet accessory of claim 7, wherein the battery is disposed within the smart housing.

9. The pet accessory of claim 1, wherein the band comprises a vibration emitter.

10. The pet accessory of claim 9, wherein the vibration emitter is selected from one of a motor-drive based vibrator, a ceramic based vibrator, a percussion-based vibrator or a transducer-based vibrator.

11. The pet accessory of claim 3, wherein the memory comprises a plurality of prerecorded voice commands for playback on the speaker upon receiving a live voice command or a signal from a remote electronic device.

12. The pet accessory of claim 1, wherein the GPS module creates a geofence around the pet accessory.

13. The pet accessory of claim 11 further comprising a timer circuit for playing at least one of the plurality of prerecorded voice commands at a predetermined time interval.

14. A voice command pet collar comprising:
a flexible band having a buckle and a clasp for securing the flexible band to a neck of a pet;
a smart housing attached to the flexible band and comprising a microphone, a speaker, a memory, an electronic circuit, a wireless communication module and a sensor;
at least one LED light disposed on the flexible band and powered by a battery;
at least one prerecorded message stored in the memory for playback; and
a GPS module in communication with the memory, wherein the GPS module defines an invisible boundary around the voice command pet collar.

15. The voice command pet collar as recited in claim 14, wherein the sensor monitors at least one of a temperature, a wetness, a force or motion, or a heart rate of the pet.

16. The voice command pet collar as recited in claim 14 further comprising a vibration emitter that is activated by a voice command.

17. The voice command pet collar as recited in claim 16, wherein the vibration emitter is selected from one of a motor-drive based vibrator, a ceramic based vibrator, a percussion-based vibrator, or a transducer-based vibrator.

18. The voice command pet collar as recited in claim 14 further comprising a control panel for operating the microphone and speaker.

19. The voice command pet collar as recited in claim 14, wherein the at least one LED light and the speaker are activated as the voice command pet collar approaches the invisible boundary.

20. A pet collar for controlling and training a pet, the pet collar comprising:
a band sized and configured to fit around a neck of the pet, the band having a clasp for securing the band to the pet;
a smart housing removably connected to the band;
a plurality of LED lights and at least one sensor;
a microphone;
a speaker;
an electronic circuit;
a wireless communication module;
a GPS module;
a vibration emitter
a shock emitter; and
a battery, wherein the GPS module defines an invisible perimeter around the pet collar and when the pet approaches the invisible perimeter at least one of the speaker, the plurality of LED lights, the vibration emitter or the shock emitter is activated.
